(19) United States
(12) Patent Application Publication
(10) Pub. No.: US 2015/0310760 A1
(43) Pub. Date: Oct. 29, 2015

(54) SYSTEM AND METHOD FOR SMOKING CESSATION

(71) Applicants: Adam Knotts, Indianapolis, IN (US); Kigho Emenike, Indianapolis, IN (US)

(72) Inventors: Adam Knotts, Indianapolis, IN (US); Kigho Emenike, Indianapolis, IN (US)

(73) Assignee: Mobilify Technology, Inc., Indianapolis, IN (US)

(21) Appl. No.: 14/695,275

(22) Filed: Apr. 24, 2015

Related U.S. Application Data
(60) Provisional application No. 61/983,827, filed on Apr. 24, 2014.

(51) Int. Cl. G09B 19/00; G09B 7/00

(52) U.S. Cl. CPC G09B 19/00; G09B 7/00

(57) ABSTRACT

A system and method for smoking cessation is disclosed. The method includes receiving a plurality of smoking events and cravings from a user through an electronic device, transmitting to the electronic device one or more queries for each of the plurality of smoking events, each of the one or more queries prompting the user to enter information related to each smoking event, receiving the information related to each smoking event from the electronic device, generating a user smoking event metrics based at least in part on the information, and evaluating the user smoking event metrics against a plurality of smoking cessation badge conditions, each smoking cessation badge condition identifying a smoking cessation badge.

### CROSS-REFERENCE TO RELATED APPLICATION

The present application claims the benefit of commonly owned U.S. Provisional Patent Application Ser. No. 61/983,827 filed on Apr. 24, 2014, which is hereby incorporated by reference in its entirety.

### BACKGROUND

Smoking cessation programs, tricks, pills, and tools are well known in the art. There exists a long history of research and effort invested into helping people find the best way to quit smoking. Some programs suggest that smokers should reach out to friends and loved ones when a craving to smoke hits, others suggest that smokers exert physical exercise to lessen cravings, while even others suggest that smokers gum or other products will lessen a smoking craving when it comes.

Most of these programs, however, fail to provide an individual with a way to easily log his or her cravings and psychological and environmental events surrounding such craving that may corroborate into craving triggers. That is, a craving can come at any time, in any place, and for a number of reasons, and most smoking cessation programs fail to give individuals the tools needed to immediately take action when a craving or smoking event occurs.

The years of research on smoking cessation creates another advantage that most smoking cessation programs fail to appreciate: clinical guidelines. A smoking cessation program may adhere to clinical guidelines on paper and suggest that individuals follow those clinical guidelines when left to work through the program, but these smoking cessation programs fail to give individuals the tools necessary to help adhere to these clinical guidelines as the individual advances towards cessation.

Another issue in smoking cessation programs is the failure to let friends and loved ones keep smokers honest as they advance towards cessation. If a smoker is attempting to log his or her activity with smoking, the smoker may forget or intentionally choose not to log a smoking event as it occurs and mistakenly believe that he or she is further towards cessation than reality. Current cessation programs fail to empower friends and loved ones to log smoking events that were not properly recorded.

Accordingly, there exists a need for a system and method for smoking cessation.

### BRIEF DESCRIPTION OF THE DRAWINGS

FIG. 1 illustrates a flowchart of a method for smoking cessation according to at least one embodiment of the present disclosure.

FIG. 2 displays the architecture of a system for smoking cessation according to at least one embodiment of the present disclosure.

FIG. 3 displays an entity relationship model used in a method or system for smoking cessation according to at least one embodiment of the present disclosure.

FIG. 4 illustrates a flowchart of a method for smoking cessation according to at least one embodiment of the present disclosure.

FIG. 5 illustrates a flowchart of a method for smoking cessation according to at least one embodiment of the present disclosure.

FIG. 6A displays a wireframe of a user interface presented in association with a system and/or method for smoking cessation according to at least one embodiment of the present disclosure.

FIG. 6B displays a wireframe of a user interface presented in association with a system and/or method for smoking cessation according to at least one embodiment of the present disclosure.

FIG. 6C displays a wireframe of a user interface presented in association with a system and/or method for smoking cessation according to at least one embodiment of the present disclosure.

FIG. 6D displays a wireframe of a user interface presented in association with a system and/or method for smoking cessation according to at least one embodiment of the present disclosure.

FIG. 6E displays a wireframe of a user interface presented in association with a system and/or method for smoking cessation according to at least one embodiment of the present disclosure.

FIG. 6F displays a wireframe of a user interface presented in association with a system and/or method for smoking cessation according to at least one embodiment of the present disclosure.

FIG. 7A displays a wireframe of a user interface presented in association with a system and/or method for smoking cessation according to at least one embodiment of the present disclosure.

FIG. 7B displays a wireframe of a user interface presented in association with a system and/or method for smoking cessation according to at least one embodiment of the present disclosure.

FIG. 7C displays a wireframe of a user interface presented in association with a system and/or method for smoking cessation according to at least one embodiment of the present disclosure.

FIG. 8 displays a wireframe of a user interface presented in association with a system and/or method for smoking cessation according to at least one embodiment of the present disclosure.

FIG. 9 displays a wireframe of a user interface presented in association with a system and/or method for smoking cessation according to at least one embodiment of the present disclosure.

FIG. 10 displays a wireframe of a user interface presented in association with a system and/or method for smoking cessation according to at least one embodiment of the present disclosure.

FIG. 11 displays a wireframe of a user interface presented in association with a system and/or method for smoking cessation according to at least one embodiment of the present disclosure.

FIG. 12A displays a wireframe of a user interface presented in association with a system and/or method for smoking cessation according to at least one embodiment of the present disclosure.

FIG. 12B displays a wireframe of a user interface presented in association with a system and/or method for smoking cessation according to at least one embodiment of the present disclosure.

FIG. 12C displays a wireframe of a user interface presented in association with a system and/or method for smoking cessation according to at least one embodiment of the present disclosure.

FIG. 13A displays a wireframe of a user interface presented in association with a system and/or method for smoking cessation according to at least one embodiment of the present disclosure.

FIG. 13B displays a wireframe of a user interface presented in association with a system and/or method for smoking cessation according to at least one embodiment of the present disclosure.

FIG. 13C displays a wireframe of a user interface presented in association with a system and/or method for smoking cessation according to at least one embodiment of the present disclosure.

FIG. 13D displays a wireframe of a user interface presented in association with a system and/or method for smoking cessation according to at least one embodiment of the present disclosure.

### DETAILED DESCRIPTION

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

This detailed description is presented in terms of programs, data structures or procedures executed on a mobile device, computer or network of computers. The software programs implemented by the system may be written in languages such as Ruby, PHP, Perl, ASP.net, Java, HTML, HTML5, CSS3, Bootstrap, Python, C, C++, C#, Javascript, the Spring Framework, Node.js, Express, Underscore, Require, Backbone, Marionette, Handlebars, Mustache, Jquery, Modernizr, Sass, Compass, Angular, Scala, and/or the Go programming language. It should be appreciated, of course, that one of skill in the art will appreciate that other language may be used instead, or in combination with the foregoing and that web and/or mobile application frameworks may also be used, such as, for example, Ruby on Rails, Jo, Twitter bootstrap, and others.

In some embodiments, a user may install a smoking cessation application as discussed in the present disclosure on a mobile device, smartphone, tablet, wearable technology, or similar computing device that may be taken with the user. In some embodiments, the smoking cessation application may be housed on a web infrastructure and accessed by a user through an electronic device over a network through a web browser.

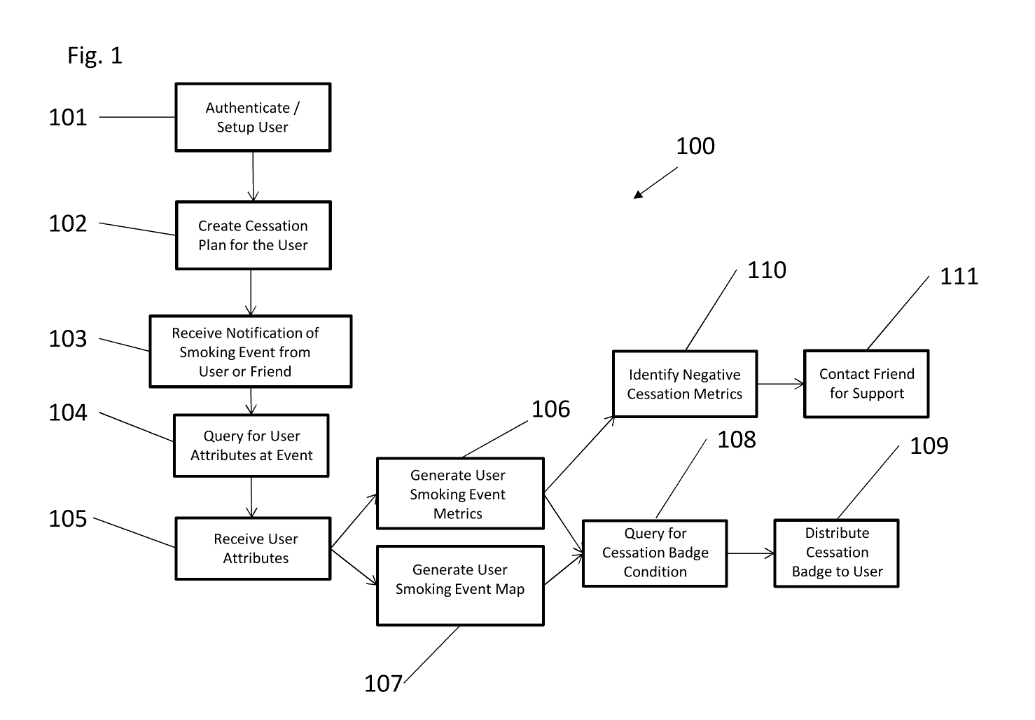

Referring now to FIG. 1, it is shown a method 100 for smoking cessation. As shown in FIG. 1A, the method 100 includes authenticating a user in step 101, creating a cessation plan for the user in step 102, receiving notification of a smoking event from the user or a friend in step 103, querying the user for attributes associated with the event in step 104, receiving the attributes from the user in step 105, generating user smoking event metrics in step 106, generating a user smoking event map in step 107, querying metrics against one or more cessation badge conditions in step 108, distributing cessation badge to the user in step 109, identifying negative cessation metrics for the user in step 110, and contacting a friend for support in step 111.

In at least one embodiment of the present disclosure, the method 100 includes authenticating a user in step 101. In such embodiments, upon accessing the smoking cessation application, the smoking cessation application may generate a transmittal request to web services or other infrastructure over a computer network requesting access to a user smoking profile. In such embodiments, the infrastructure may query the device to determine whether the user is an already registered user within the smoking cessation system. If not, the smoking cessation system may request that the user register an account with a username and password. It should be appreciated that the user may register an account through the smoking cessation application in a variety of ways and by providing a variety of credentials, such as, for example, simple email and password, username and password, PIN, openid, OAuth, or others.

In some embodiments, when the user attempts to access the smoking cessation system through the smoking cessation application, the system may request that the user provide access credentials and/or otherwise authenticate to his or her identity to the system prior to performing any other steps in the method 100. In such an embodiment, the smoking cessation application may authenticate to the system by providing a username and password, referencing a previously generated session (i.e. through a cookie), through a third-party authentication provider (i.e. OAuth, openid, or others), providing a trusted certificate, token or other one-time pad resource in addition to PIN, or other authentication mechanism. In such embodiments, the system will verify the credentials provided by the user and, if accurate, enable the user to access his or her profile and other attributes within the smoking cessation system.

In some embodiments, when the user accesses the smoking cessation system for the first time, the user may be requested to register as discussed above. During the registration process, the user may be prompted to provide information concerning his or her identity, smoking habits, and other attributes. The user may further be requested to fill out one or more clinical surveys or evaluation techniques to enable the smoking cessation system to determine a user's status according to clinical guidelines.

For example, a user may be prompted to fill out a Horn-Russell Tobacco Scale to determine the user's level of addiction based on a scale. The Horn-Russell Tobacco Scale, for example, may ask the user to answer a multitude of questions with scores that, when calculated together, provide a level of addiction on a scale. By requesting that a user perform such clinical evaluation during the registration process, the smoking cessation system may be configured to tailor the user's smoking cessation program and use of the smoking cessation application in a manner that most aligns with the user's level of addiction or other clinical guidelines. It should be appreciated, of course, that any clinical survey or test with scored questions may be administered by the smoking cessation application, such as, for example, the Fagerstrom Test for Nicotine Dependence.

In some embodiments, during user registration in step 101, the smoking cessation application may prompt the user to answer whether the user would like to share his or her cessation plan and progress with a friend. If the user chooses to share his or her cessation plan and progress with a friend, the smoking cessation application may prompt the user to identify the friend via email, contact stored in a mobile phone, SMS, Facebook, Twitter, or other network-based profile or identifier. In embodiments where the user identifies the friend via contact in his or her mobile phone, the smoking cessation application may import identifiers for the friend from the user's contact list stored in the mobile phone, such as, for example, email address, telephone number, etc. Then, the smoking cessation system may prompt the identified friend to register for an account with the smoking cessation system and a unique identifier for the user to monitor the user's progress, report smoking events for the user, and otherwise interact with the user's smoking cessation program. The smoking cessation system may query the friend for additional information to determine the friend's likelihood of helping the user adhere to the smoking cessation program. Such information may include, but is not limited to, whether the friend is a current smoker, relationship to the user, age, how often the friend is in contact with the user, etc. In some embodiments, the smoking cessation application may ask the friend whether he or she is a smoker and, if so, prompt the friend to register for a smoking cessation program through the smoking cessation system.

In some embodiments, the smoking cessation system and smoking cessation application may transmit, store, or otherwise handle categories of information that may be subject to regulatory requirements, data security/privacy laws, or other restrictions (i.e. personally identifiable health information in scope of the Health Insurance Portability and Accountability Act). In such embodiments, the transmission and storage of such information on the user device, in the smoking cessation system and in transit between the two may be protected according to requirements in such regulations or standards generally accepted in the industry (i.e. NIST standards). These protections may include, but are not limited to, device-based encryption or storage of information in an encrypted file for at-rest protection and TLS, SSL, and other encryption protocols for protecting data in transit.

In at least one embodiments of the present disclosure, the method 100 includes creating a cessation plan for the user in step 102. In such embodiments, the clinical surveys, information, and attributes of the user may be evaluated to create a tailored cessation plan for the user in step 102. In such embodiments, the cessation plan may be generated based on clinical guidelines, such as, for example, clinical practice guides published by the Center for Disease Control, Department of Health and Human Services, or other research groups devising programs and plans to help individuals stop smoking.

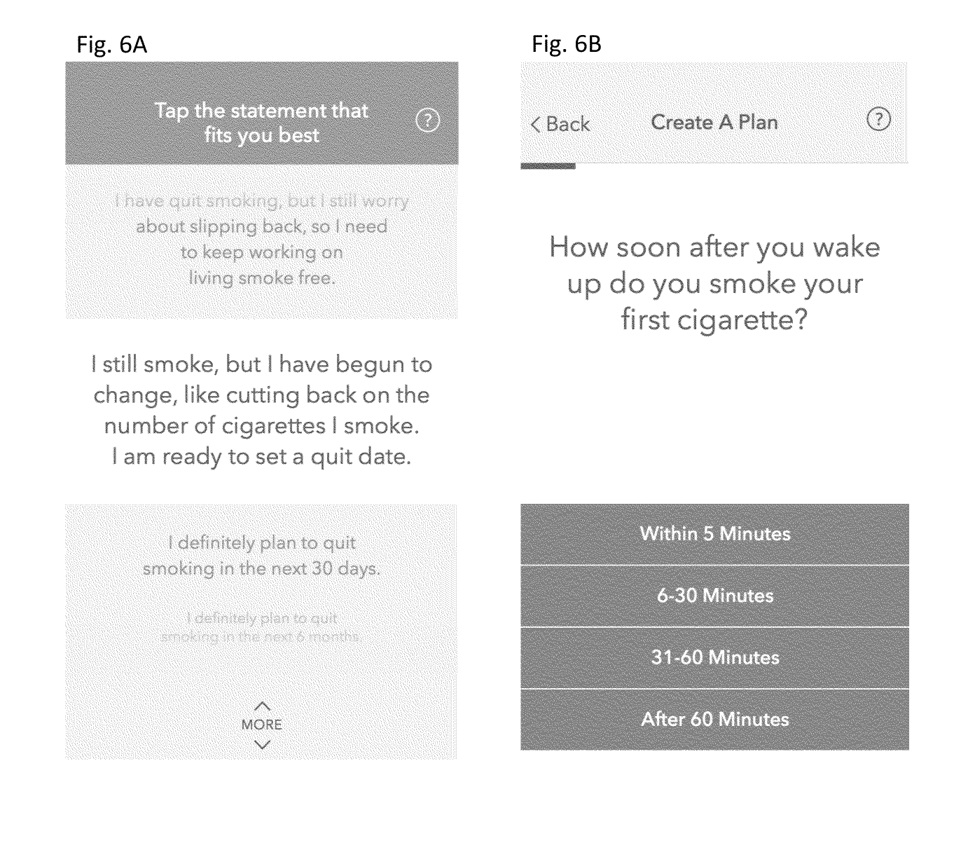

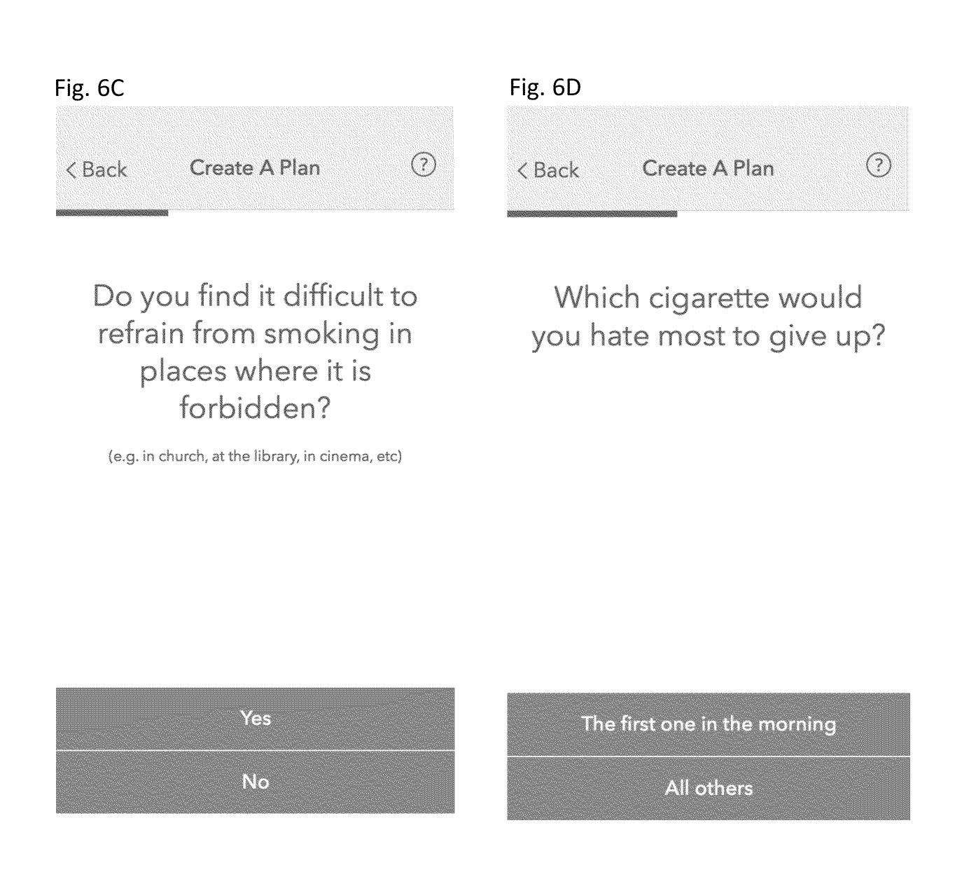

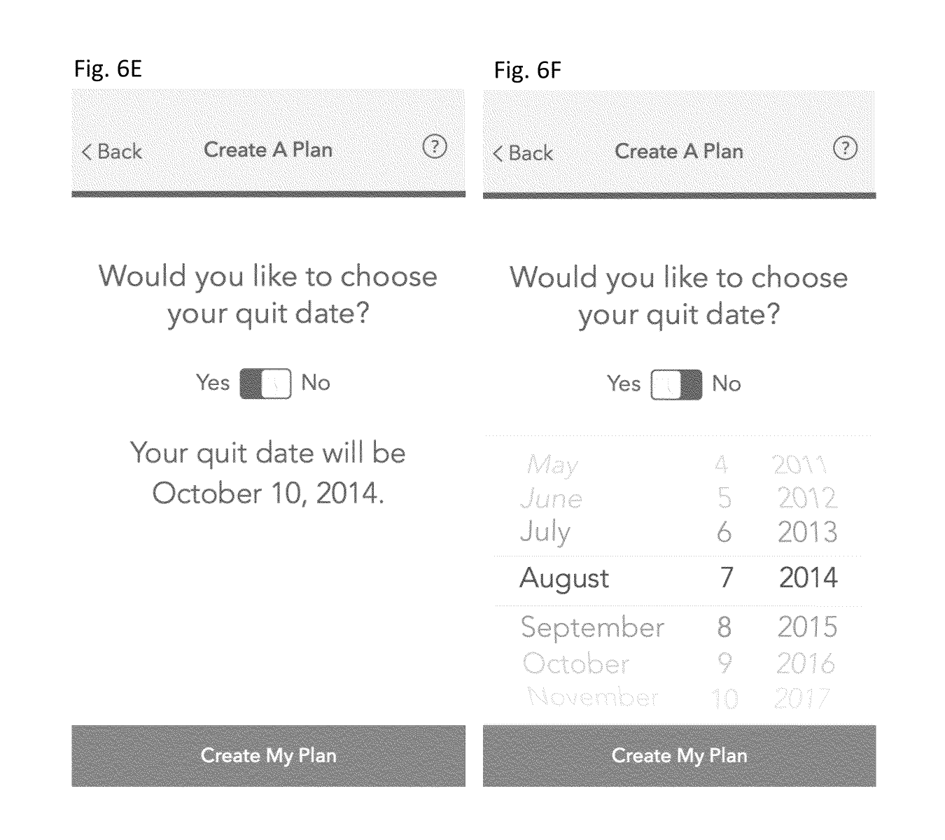

In some embodiments, a user may create his or her individual cessation plan in step 102. In such embodiments, a mobile application, web service infrastructure, or other network-based application will prompt the user with various questions that aid the service in creating a tailored cessation plan. For example, the application may ask the user for his or her desires when using the application, such as, for example, those shown in FIG. 6A. A user, for example, may desire to quit smoking completely within the next 30 days, 6 months, or simply to cut back on smoking. Based on this selected user goal, the application may set different goals in the user's individualized cessation plan in step 102.

It should be appreciated that the user may be prompted with further questions in step 102 to create a more detailed and tailored cessation plan for the individual user. For example, the user may be prompted to provide information regarding how often the user smokes, how long after waking up the user smokes (such as, for example, shown in FIG. 6B), the user's tendencies which spark smoking (i.e. FIG. 6C), the types of cigarettes that the user enjoys (i.e. FIG. 6D), and other questions. It should be appreciated that the examples disclosed herein and the screenshots displayed in FIGS. 6A-6D are merely examples and the application may be configured to have the user input any response, information, metrics, and the like that can be used to generate a tailored cessation plan in step 102.

In some embodiments, in step 102, based on user responses and/or information obtained by the smoking cessation application, a the smoking cessation application may set a quit date for the user, such as, for example, as shown in FIG. 6E. In some embodiments, this date may be calculated from the user response to the question of when he or she wishes to quit smoking (i.e. 6 months, 30 days). In other embodiments, this date may be calculated based on responses to other questions, health concerns, and the like as identified by the smoking cessation application and information obtained therein. In some embodiments, the user may input his or her own date to quit smoking, such as, for example, shown in FIG. 6F.

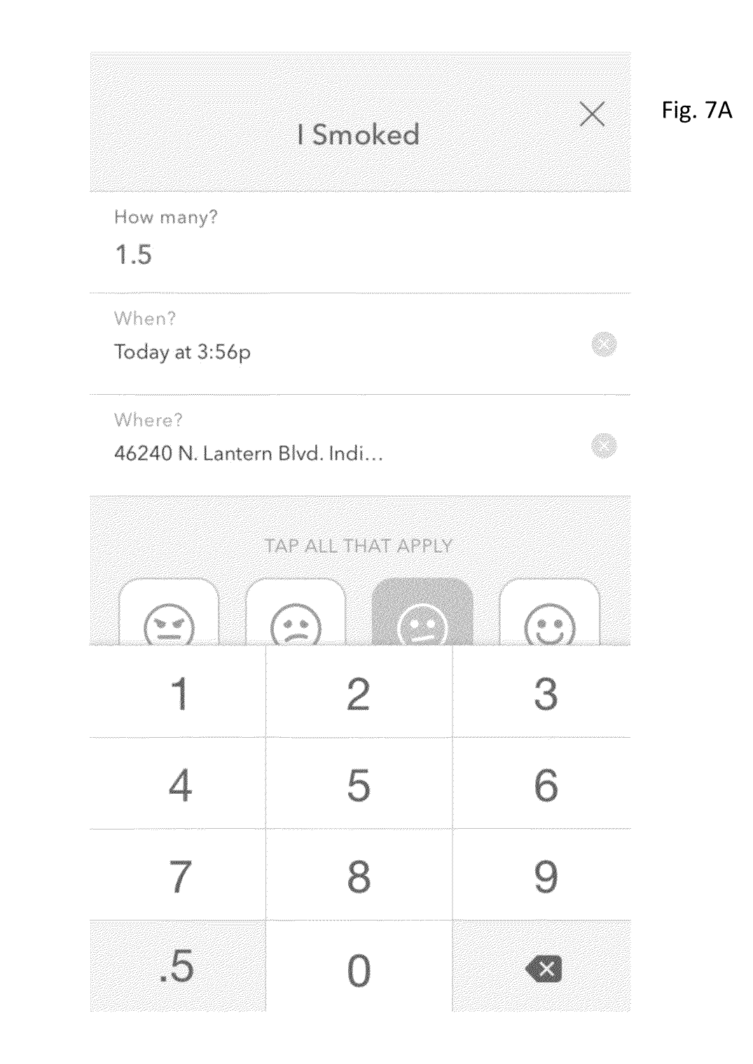

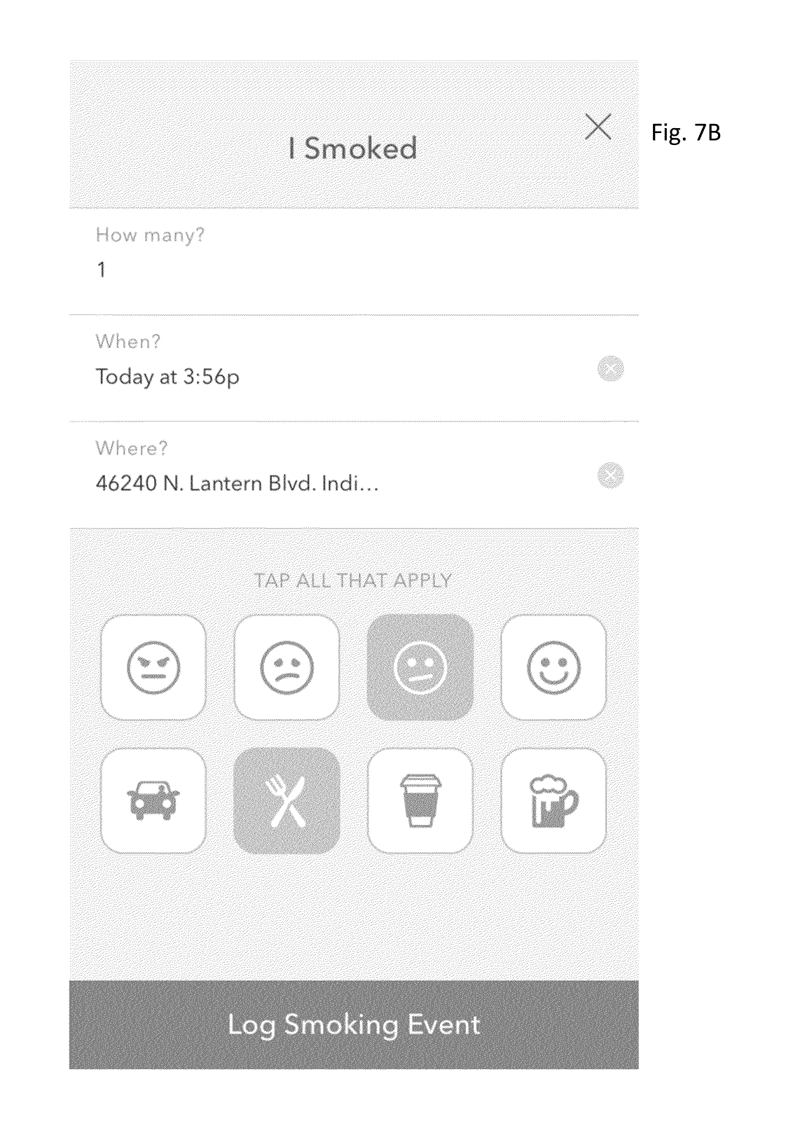

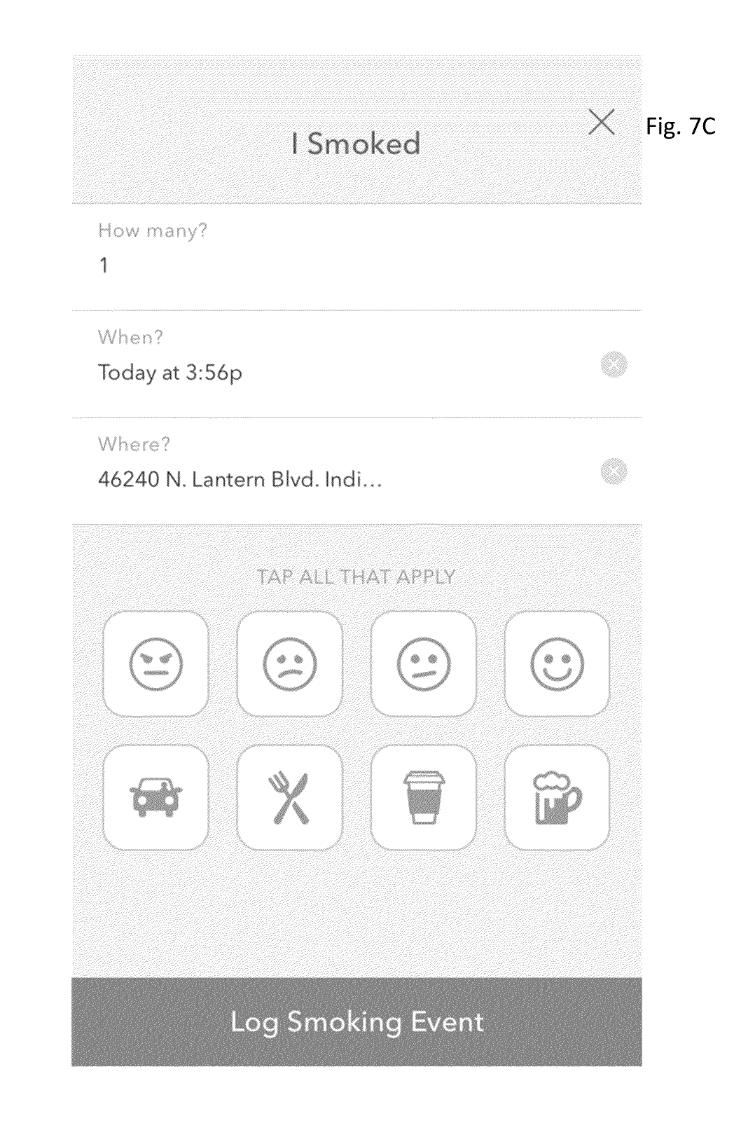

In at least one embodiment of the present disclosure, the method 100 includes receiving a notification of a smoking event from a user or friend in step 103. In such an embodiment, a user or friend may submit notification through a smoking cessation application to a smoking cessation system indicating that the user has smoked a cigarette and/or experienced a craving to smoke. An example interface for such submission from a user is shown in FIG. 7A. In some embodiments, receiving an indication that the user has smoked or experienced a craving to smoke may prompt the smoking cessation application to query the user for attributes related to the smoking event or craving in step 104. The smoking cessation application may prompt the user to describe the smoking event or craving by providing details. Details may include, but are not limited to, geographic location, the user's psychological mood, the time of the event, activities performed by the user prior to smoking or experiencing a craving, and others. Example interfaces to input information regarding the smoking activity are shown in FIGS. 7A, 7B, and 7C.

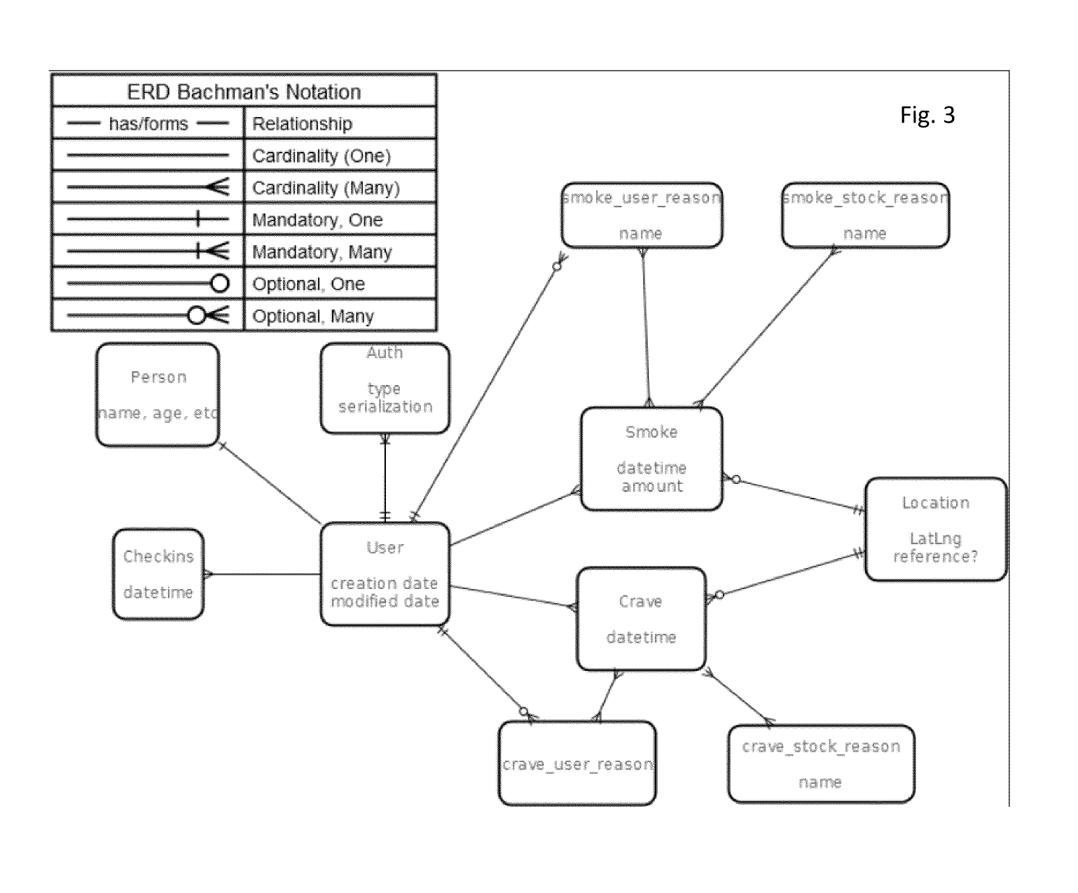

In some embodiments, the attributes obtained in step 104 may be obtained through a preconfigured list of attributes in a smoking cessation application either configured internally by the application or provided as a list from a smoking cessation system. For example, a preconfigured list of moods may be stored within the smoking cessation application that would be presented to the user upon recording a smoking event for easy classification of the user's mood. It should be appreciated, in this example, that providing a preconfigured list of moods will enable the smoking cessation system to more efficiently classify the user's mood when smoking than a free-form text box. In some embodiments, the smoking cessation application may transmit the user's geographic location through mobile services on a smartphone or otherwise when recording a smoking event. It should be appreciated that the geographic location where the user smokes may be relevant in later analysis in determining that the user smokes often at work, at home, or at his or her favorite restaurant. An example of various attributes and other information recorded within the smoking cessation application in the smoking cessation system are shown in the model displayed on FIG. 3. It should be appreciated, of course, that FIG. 3 is an example of such attributes and information and that additional information and attributes may be recorded.

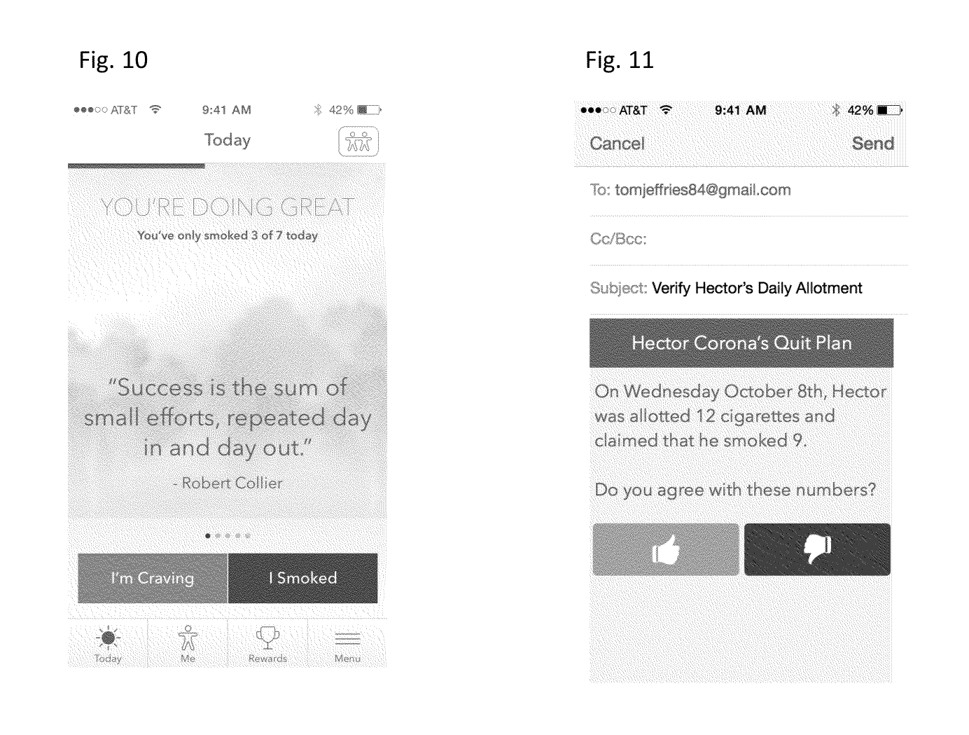

In some embodiments, the smoking cessation mobile application may display positive reinforcement to a user when the user has not reported a smoking event in a length of time or when a user has reported less smoking events than he or she is allotted according to the user's smoking cessation plan. For example, in the event that a user smokes only three times in a day when he or she is allotted 7 cigarettes, the mobile application may display positive reinforcement to the user. An example interface showing positive reinforcement is shown in FIG. 10.

A friend using a smoking cessation mobile application may assist a user with smoking cessation and provide results associated with a smoking event in step 104. In such an embodiment, a friend may input information about the smoking event for the user in step 104. In some embodiments, the friend may keep a user honest by affirming or denying information about smoking put in by the user, such as, for example, as shown in FIG. 11.

For example, a user may be experiencing an exceptionally stressful day at work and decide to take a cigarette break. After stepping outside to smoke the cigarette, the user may open his or her smoking cessation application on a smartphone and record that a smoking event just occurred. The smoking cessation application, then, may prompt the user to provide the geographic location of the smoking event and the user's mood when smoking. In this example, the smoking cessation application may have a preconfigured list of mood choices for easy classification of moods at a later time. In this example, the user may select ‘stressed’ from the preconfigured list of mood choices. In this example, the smoking cessation application securely transmits the smoking event, the time and date, the geographic location, and the user's mood of ‘stressed’ to the smoking cessation system.

In another example, a friend is out to dinner with a user. After dinner, the user steps outside to smoke a cigarette. If the friend is registered with the smoking cessation system as a friend, as described above, the friend may open a smoking cessation application and log the user's smoking event. After logging the user's smoking event, the smoking event will be waiting for the user to provide attributes related to the smoking event, such as, for example, the user's mood smoking. In this example, the smoking cessation application may capture the geographic location of the friend when submitting the smoking event and log such location as the location of the smoking event.

In at least one embodiment of the present disclosure, the user transmits the user attributes related to the smoking event in step 105. In some embodiments, the user attributes related to the smoking event are transmitted over a computer network, such as the Internet, to a smoking cessation system. It should be appreciated that the attributes may transmitted in a variety of ways, such as, for example, through a RESTful service at the smoking cessation system, a web services layer, a direct database connection from the smoking cessation application to the smoking cessation system, an FTP service, email, SMS, or other communication technology. In some embodiments, the smoking cessation system may store the smoking event and related attributes for the user in a database.

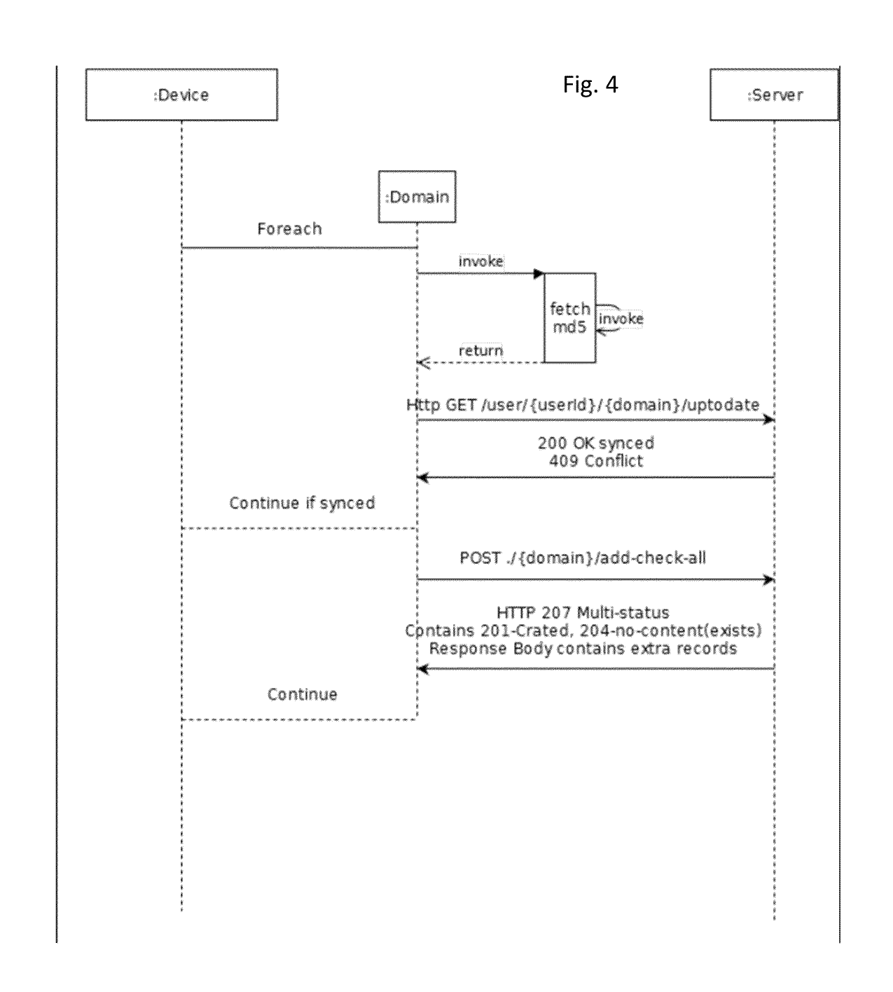

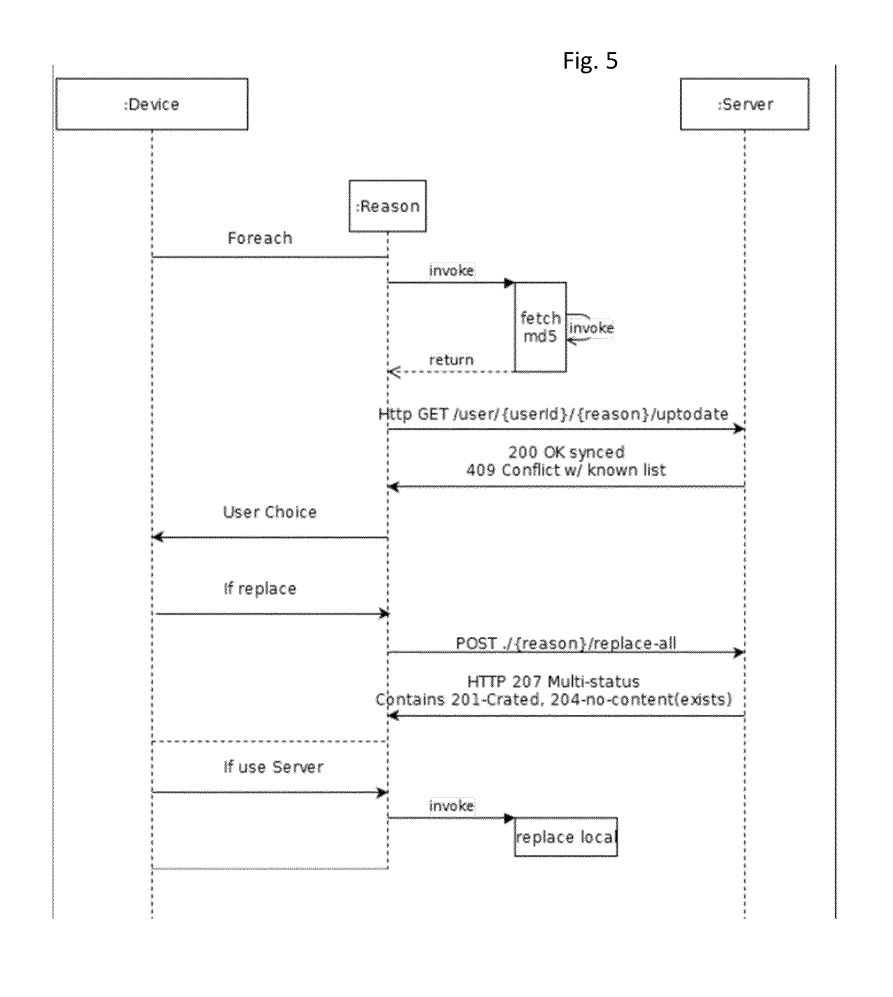

It should be appreciated, of course, that steps 103, 104 and 105 may be repeated as additional smoking events and/or cravings occur and are recorded in a smoking cessation application. FIGS. 4 and 5 display an example of a flowchart of data synchronization for information passed from the smoking cessation application to the smoking cessation system. As shown in FIG. 4 information between the electronic device in the smoking cessation application may be synced with information in the smoking cessation system on a period basis. As shown in FIG. 5, in the event that discrepancies occur between information stored in the electronic device and at the smoking cessation system, the user may be prompted how to handle such discrepancies.

In at least one embodiment of the present disclosure, the method 100 includes generating user smoking event metrics in step 106. In such an embodiment, smoking events and attributes related to smoking events may be correlated in a smoking cessation system to generate metrics. Metrics may include, but are not limited to, the number of times a user has smoked during a time period, the most common moods a user is experiencing that lead to smoking events, the most common activities performed by a user that lead to smoking events, the percentage increase or decrease in smoking events in a time period compared to a second time period, and comparisons of user smoking events and attributes with a clinical practice guides. In some embodiments, the smoking cessation system may transmit analytics reports, metrics, and other information to the user through a smoking cessation application.

In some embodiments, smoking events and attributes related to smoking events are stored in a database accessible by a smoking cessation system. In such embodiments, the smoking cessation system may aggregate, manipulate, or otherwise evaluate data from the smoking events and attributes to generate user metrics that may be pertinent to the user in advancing towards smoking cessation.

In at least one embodiment of the present disclosure, the method 100 includes generating a user smoking event map in step 107. In such embodiments, the user smoking event map may include a listing of all or a portion of smoking events (such as, for example, in a time period) viewable on a map within a smoking cessation application. In such embodiments, the smoking cessation application may generate the map through a third party application programming interface mapping tool, such as, for example, CloudMade, ESRI ArcGIS, Google Maps, Leaflet, MapQuest, Microsoft Bing, and Nokia Here. In such an embodiment, when the user requests a smoking event map in the smoking cessation application, the smoking cessation application may pull geographic information of smoking events from the smoking cessation system over a computer network and transmit the geographic information of smoking events to an application programming interface to generate an interactive map. In some embodiments, the smoking cessation application may query the mapping application programming interface and transmit the interactive map to the smoking cessation application. In even other embodiments, the smoking cessation application may store all geographic information related to smoking events and interact directly with the mapping application programming interface to generate an interactive map for the user.

In some embodiments, the map displays a pin for each smoking event. A user may zoom in or out on the map, move the map to other locations, and view his or her current location from the user's electronic device. In some embodiments, the map displays different colors of pins on geographic locations with a legend that identifies the number of times a user has smoked at such geographic location. For example, a map may display a red pin on the geographic location of the user's home indicating that the user has recorded 15 smoking events at the user's home whereas the map may display a blue pin on the geographic location of the user's work indicating that the user has recorded 5 smoking events at work. It should be appreciated, of course, that the map may display any colors for any range of smoking events.

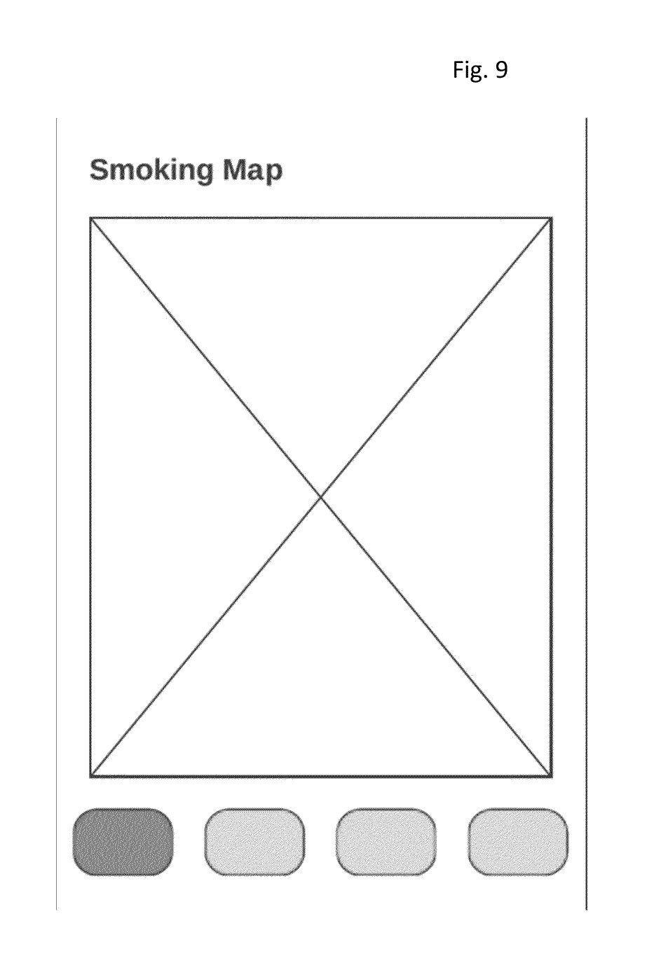

In another example, the map may be tailored to only show smoking events over a course of time. For example, the map may display all smoking events recorded by the user in the last week, the last month, or other time period. It should be appreciated, of course, that other time periods may be used. An example interface to display a user smoking map is shown in FIG. 9.

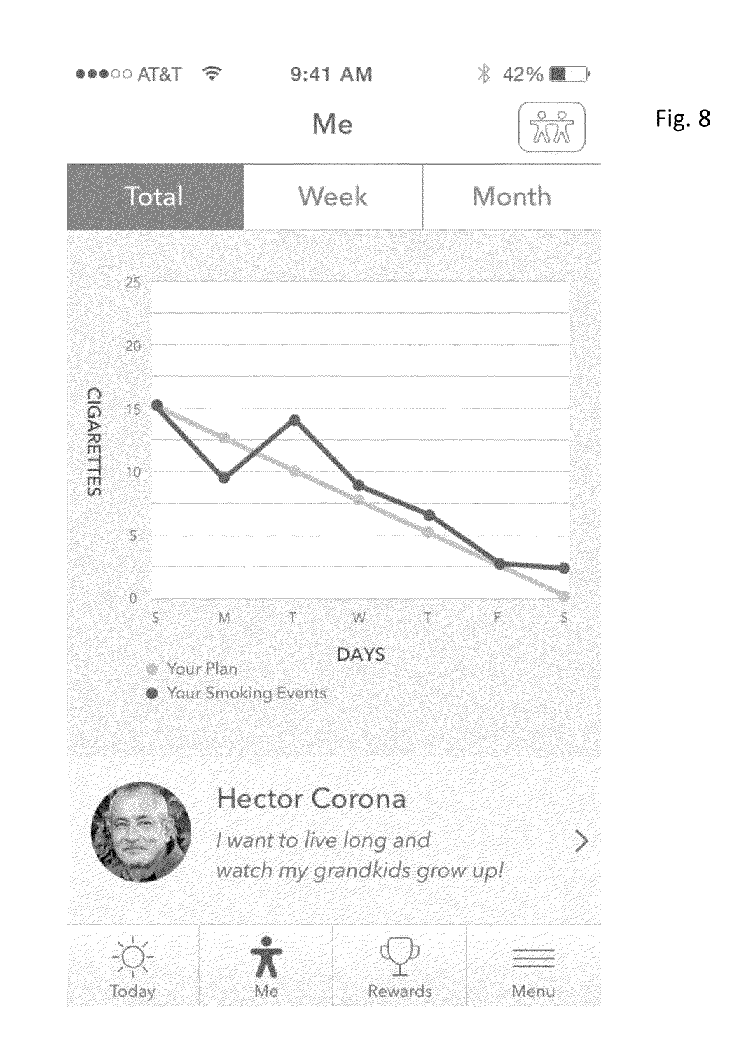

In some embodiments, the user smoking map may include information showing the user's smoking trends and how he or she is tracking towards the created goal in step 102. In such embodiments, the smoking event map is a report that displays the number of times that the user smokes on a given day and how that smoking activity relates to the user's tailored plan, such as, for example, the interface shown in FIG. 8.

In at least one embodiment of the present disclosure, the method 100 includes querying a database of smoking events and attributes for cessation badge conditions. It is known in the art that gamification may help individuals quit smoking. Some applications provide a gamification experience that enables a user to track how long it has been since the user has last smoked and display to the user various metrics, such as time saved, money saved, the date that the user quit smoking, and others. Other applications create a social network of persons attempting to quit smoking and invites discussion on various tasks users may engage as they progress towards smoking cessation. The present disclosure provides a novel approach to gamification of smoking cessation through the use of smoking cessation badges. The previously mentioned applications fail to appreciate the data-rich environment of smoking cessation. The present disclosure's storage of each individual smoking event and related attributes to smoking events creates a data-rich environment that is ripe for gamification. In some embodiments, then, a smoking cessation system may create one or activity badges of smoking cessation that may be earned by a user of a smoking cessation application. Badges may be generated for various activities related to smoking cessation, such as, for example, completing a Fagerstrom Test for Nicotine Dependence, a commitment to smoking cessation, tracking a user's first craving, logging a set number of cravings (i.e. 10), sharing smoking cessation progress via social media, recording a set number of cravings without recording a smoking event, and others. The smoking cessation application may reward user behavior through the issuance of such badges that the user may then share with his or her friends over social media, email, or other communication platform through the smoking cessation application.

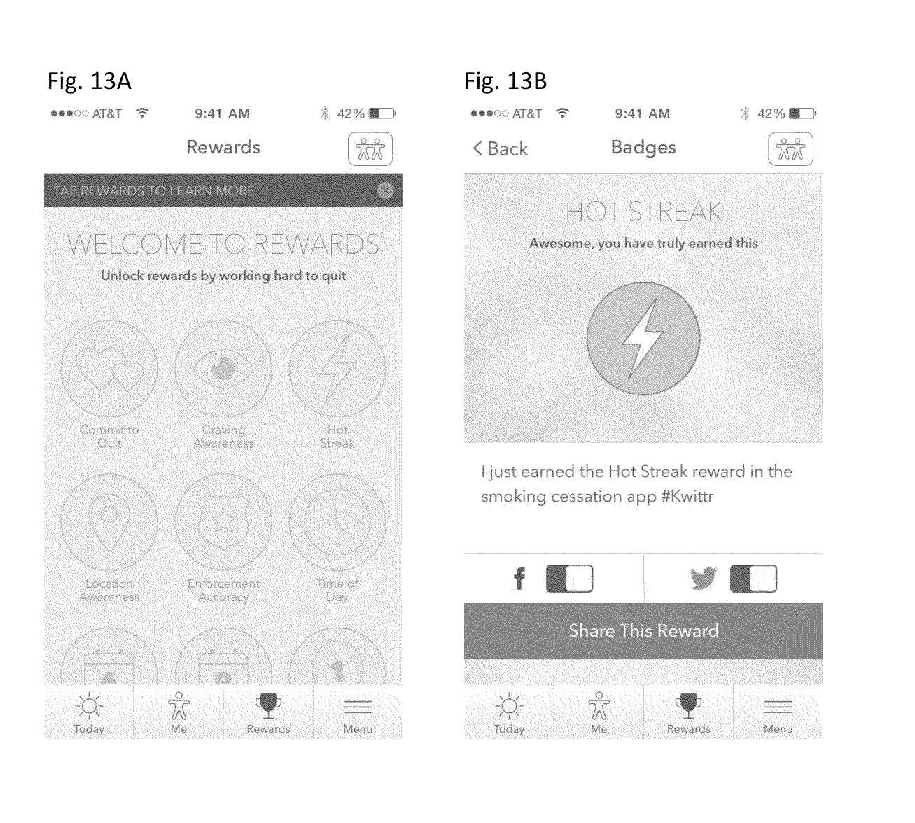

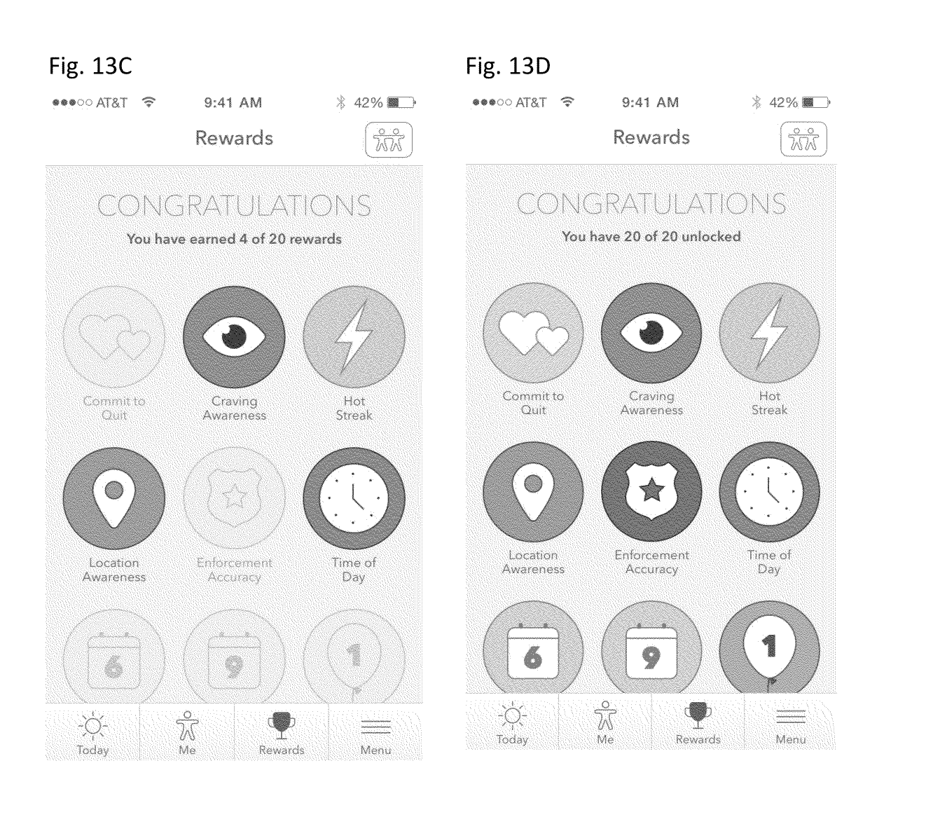

In some embodiment, the smoking cessation application and/or smoking cessation system stores badge conditions that may be triggered upon smoking events, cravings, attributes, or other metrics stored in the smoking cessation system. In step 108, these badge conditions may be evaluated against metrics generated in step 106 or other information at various intervals (i.e. time-based intervals, upon receiving new information and/or attributes of cravings or smoking events, or otherwise). Upon evaluating that one or more badge conditions are met, the smoking cessation system may distribute and store one or more cessation badges related to the one or more badge conditions to the user in the smoking cessation application in step 109. In such an embodiment, the user may be prompted to share his or her smoking cessation badge earned on social media or otherwise. Example interfaces showing distribution of smoking cessation awards and badge tracking is shown in FIGS. 13A-13D.

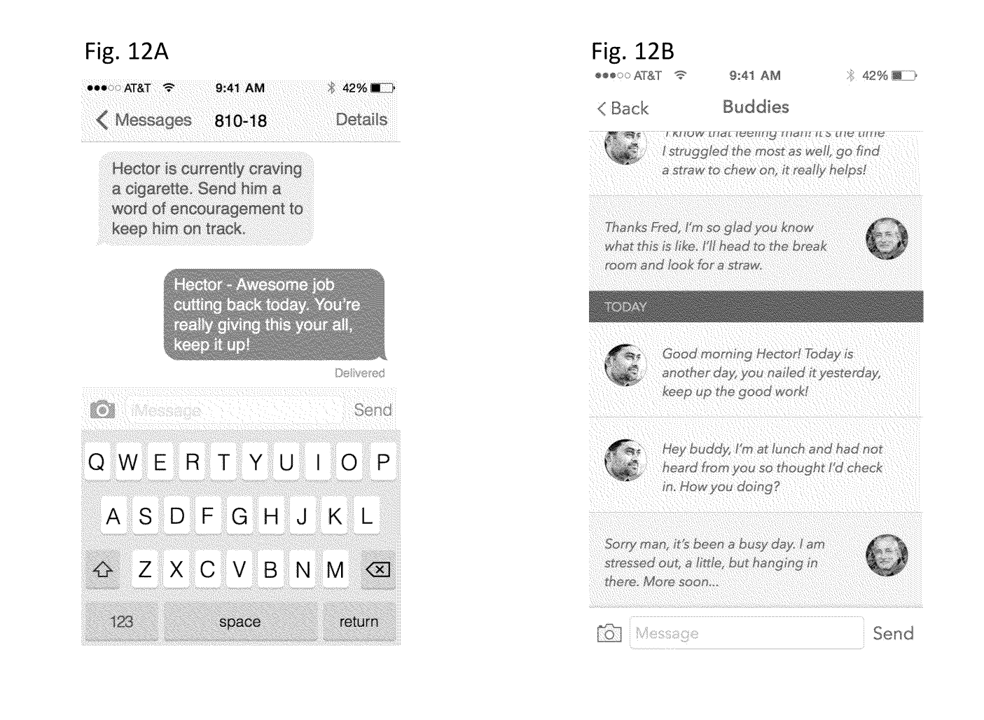

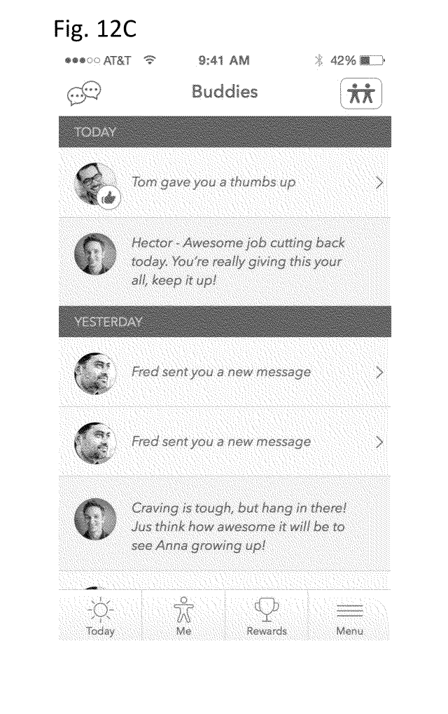

As discussed previously, a user may invite one or more friends to track the user's progress in a smoking cessation program, help the user record smoking events, and otherwise interact with the user's progress in the smoking cessation system. In such embodiments, the smoking cessation system may evaluate smoking event metrics to identify negative cessation activities in step 110. Negative cessation activities identified in step 110 may include, but are not limited to, the user increasing the number of times the user generates a smoking event each day, an increased number of cravings recorded over the user's average day, the user selecting a depressed, stressed, or otherwise negative mood when recording a smoking event, or other activity. Upon evaluating such negative cessation metrics, the smoking cessation system may contact one or more friends invited by the user for assistance in step 111. The smoking cessation system may contact such friends through an email, SMS, pop-up notification through the smoking cessation application on a smartphone, or otherwise. The notification may include the negative cessation metric identified for the user and a link to clinical information or other content on how the friend might be able to help the user get back on track with his or her smoking cessation program. Example interfaces showing user support is shown in FIGS. 12A-12C.

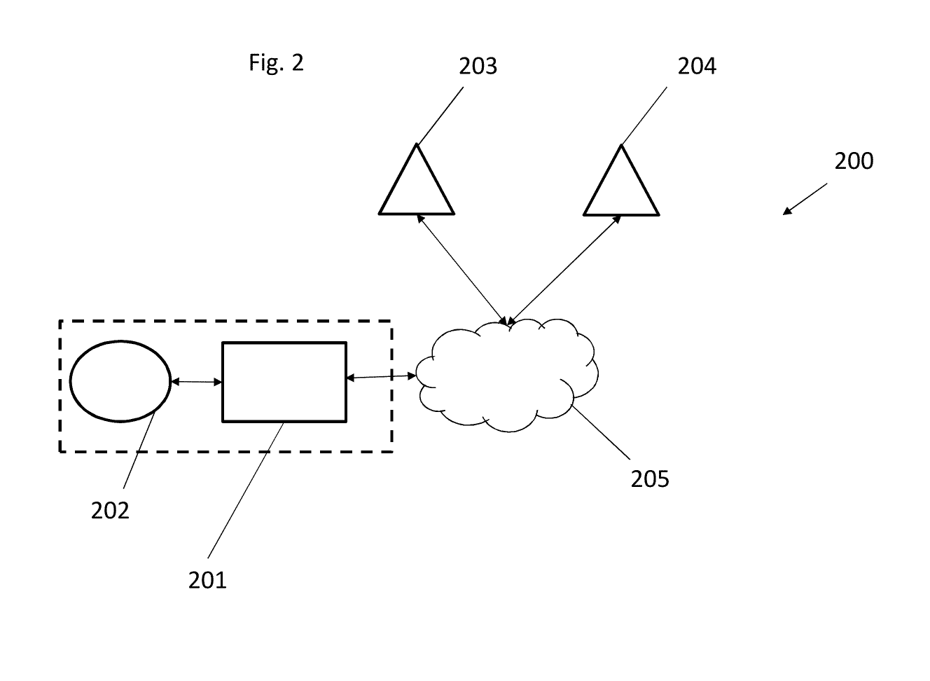

Referring now to FIG. 2, there is shown at least one embodiment of the components of the system 200 for smoking cessation according to at least one embodiment of the present disclosure. System 200 comprises server 201, database 202, electronic devices 203, 204, and computer network 205. For purposes of clarity, only two electronic devices 203, 204 are shown in FIG. 2. However, it is within the scope of the present disclosure that the system 200 may have any number of electronic devices 203, 204, such as, for example, any number of users and/or friends on electronic devices 203, 204 interacting with a smoking cessation application at one time.

The electronic devices 203, 204 may be configured to transmit information to and generally interact with a web services infrastructure housed on server 201. The electronic devices 203, 204 may include a web browser, mobile application, or other network connected software such that communication with the web services infrastructure on server 201 is possible over the computer network 205. Electronic devices 203, 204 may include one or more computers, smartphones, tablets, computing devices, or systems of a type well known in the art, such as a mainframe computer, workstation, personal computer, laptop computer, hand-held computer, cellular telephone, or personal digital assistant. Electronic devices 203, 204 comprise such software, hardware, and componentry as would occur to one of skill in the art, such as, for example, one or more microprocessors, memory systems, input/output devices, device controllers, and the like. Electronic devices 203, 204 also comprise one or more data entry means (not shown in FIG. 2) operable by users of electronic devices 203, 204 for data entry, such as, for example, a pointing device (such as a mouse), keyboard, touchscreen, microphone, voice recognition, and/or other data entry means known in the art. Electronic devices 203, 204 also comprise a display means (not shown in FIG. 2) which may comprise various types of known displays such as liquid crystal diode displays, light emitting diode display, and the like upon which information may be display in a manner perceptible to the user.

As described above, the server 201 may be configured to receive authentication information, smoking events, geographic location, moods, and other attributes from the electronic devices 203, 204 to establish and evaluate user progression on a smoking cessation plan. In at least one embodiment, the server 201 accesses the database 202 to store and index smoking cessation data, smoking events, and the like as described in the method 100. The server 201 is configured to carry out one or more of the steps of methods described herein.

The electronic devices 203, 204 are further configured to provide input to the server 201 to carry out one or more of the steps of the methods described herein. Server 201 comprises one or more server computers, computing devices, or systems of a type known in the art. Server 201 further comprises such software, hardware, and componentry as would occur to one of skill in the art, such as, for example, microprocessors, memory systems, input/output devices, device controllers, display systems, and the like. Server 201 may comprise one of many well-known servers and/or platforms, such as, for example, IBM's AS/400 Server, RedHat Linux, IBM's AIX UNIX Server, MICROSOFT's WINDOWS NT Server, AWS Cloud services, Rackspace cloud services, any infrastructure as a service provider, or any platform as a service provider.

In FIG. 2, server 201 is shown and referred to herein as a single server. However, server 201 may comprise a plurality of servers, virtual infrastructure, or other computing devices or systems interconnected by hardware and software systems know in the art which collectively are operable to perform the functions allocated to server 201 in accordance with the present disclosure.

The database 202 is configured to store smoking cessation activity, such as, for example, user information, authentication credentials, friend information, smoking events, cravings, geographic locations, and other information as described herein. Database 202 is “associated with” server 201. According to the present disclosure, database 202 can be “associated with” server 201 where, as shown in the embodiment in FIG. 2, database 202 resides on server 201. Database 202 can also be “associated with” server 201 where database 202 resides on a server or computing device remote from server 201, provided that the remote server or computing device is capable of bi-directional data transfer with server 201, such as, for example, in Amazon AWS, Rackspace, or other virtual infrastructure, or any business network. In at least one embodiment, the remote server or computing device upon which database 202 resides is electronically connected to server 201 such that the remote server or computing device is capable of continuous bi-directional data transfer with server 201.

For purposes of clarity, database 202 is shown in FIG. 2, and referred to herein as a single database. It will be appreciated by those of ordinary skill in the art that database 202 may comprise a plurality of databases connected by software systems of a type well known in the art, which collectively are operable to perform the functions delegated to database 202 according to the present disclosure. Database 202 may comprise a relational database architecture or other database architecture of a type known in the database art. Database 202 may comprise one of many well-known database management systems, such as, for example, MICROSOFT's SQL Server, MICROSOFT's ACCESS, or IBM's DB2 database management systems, or the database management systems available from ORACLE or SYBASE. Database 202 retrievably stores information or documents that are communicated to database 202 from electronic devices 203, 204 or server 201.

Electronic devices 203, 204, server 201, and database 202 all communicate via computer network 205. Computer network 205 may comprise the Internet, but this is not required.

Example wireframes of graphical user interfaces for a smoking cessation application are shown in FIGS. 6-9. In such examples, the graphical user interface enables a user to record a smoking event (FIG. 6), attributes of a smoking event (FIG. 7), and view smoking metrics (FIG. 8), and a geographic map of smoking events and cravings (FIG. 9). It should be appreciated of course, that the example wireframes are merely included as examples and that other wireframes and designs for the methods and systems are within the scope of the present disclosure.

Applicant has provided Attachments A-F, each of which further describes examples and benefits of a system and method for smoking cessation according to the present disclosure. Such attachments are incorporated in their entireties herein.

While the description above refers to particular embodiments of the present invention, it will be understood that many modifications may be made without departing from the spirit thereof. The accompanying concepts are intended to cover such modifications as would fall within the true scope and spirit of the present invention. The presently disclosed embodiments are therefore to be considered in all respects illustrative and not restrictive, the scope of the invention being indicated by the appended concepts, rather than the foregoing description, and all changes which come within the meaning and range of equivalency of the concepts are therefore intended to be embraced therein.

What is claimed is:

1. A computerized method for smoking cessation, the method comprising:
receiving a plurality of smoking events and cravings from a user through an electronic device;
transmitting to the electronic device one or more queries for each of the plurality of smoking events, each of the one or more queries prompting the user to enter information related to each smoking event;
receiving the information related to each smoking event from the electronic device;
generating a user smoking event metrics based at least in part on the information; and
evaluating the user smoking event metrics against a plurality of smoking cessation badge conditions, each smoking cessation badge condition identifying a smoking cessation badge from a plurality of smoking cessation badges.

2. The computerized method of claim 1, wherein the electronic device is configured to store data associated with the plurality of smoking events in an encrypted format.

3. The computerized method of claim 1, wherein the receiving step further comprises the steps of:
determining a discrepancy between the information and a previously stored information, the discrepancy being an indication that the information is different from the previously stored information; and
resolving the discrepancy based at least on a timeline of the information and the previously stored information.

4. The computerized method of claim 1, further comprising:
issuing a smoking cessation badge from the plurality of smoking cessation based on the evaluating step to the user;
tracking which smoking cessation badges in the plurality of smoking cessation badges have previously been issued to the user; and
displaying the issued smoking cessation badges to the user through the electronic device.

5. The computerized method of claim 1, further comprising:
receiving a request from the electronic device to create a smoking cessation plan;
transmitting at least one query to the electronic device, the at least one query being associated with at least one smoking style attribute;
receiving at least one response to the at least one query from the electronic device; and
developing a tailored plan associated with the user based at least in part on the at least one response.

6. The computerized method of claim 5, wherein the at least one response is a desired quit date.

7. The computerized method of claim 5, wherein the at least one response is a preferred type of cigarette.

8. The computerized method of claim 5, wherein the at least one response is associated with the Fagerstrom Test for Nicotine Dependence.

9. A computerized method for smoking cessation, the method comprising:
receiving a request from the electronic device to create a smoking cessation plan;
transmitting at least one query to the electronic device, the at least one query being associated with at least one smoking style attribute;
receiving at least one response to the at least one query from the electronic device;
developing a tailored plan associated with the user based at least in part on the at least one response;
receiving a plurality of smoking events and cravings from a user through an electronic device;
transmitting to the electronic device one or more queries for each of the plurality of smoking events, each of the one or more queries prompting the user to enter information related to each smoking event;
receiving the information related to each smoking event from the electronic device;
transmitting the information related to each smoking event to a second electronic device, the second electronic device being operated by a friend of the user;
requesting that the friend verify the information related to each smoking event at the second electronic device;
receiving from the second electronic device support for the user, the support being associated with the user's success or failure with the tailored plan based at least in part on the information related to each smoking event.

10. The computerized method of claim 9, further comprising displaying the support to the user at the electronic device.

11. The computerized method of claim 9, wherein the support is receiving from the second electronic device as an SMS.

12. The computerized method of claim 9, further comprising:
aggregating the information related to each smoking event based on a time associated with each smoking event; and
displaying a report to the user at the electronic device based at least in part on the aggregating step, the report detailing the user's success or failure related to the tailored plan.

13. The computerized method of claim 9, further comprising:
aggregating the information related to each smoking event based on a time and geographic location associated with each smoking event; and
displaying a map to the user at the electronic device based at least in part on the aggregating step, the map detailing when and where the user experienced smoking events.

14. A system for smoking cessation, the system comprising:
a database;
a electronic device;
a server, the server configured to receive a plurality of smoking events and cravings from a user through the electronic device, store the plurality of smoking events and cravings in a database, transmit to the electronic device one or more queries for each of the plurality of smoking events, each of the one or more queries prompting the user to enter information related to each smoking event, receive the information related to each smoking event from the electronic device, generate a user smoking event metrics based at least in part on the information, and evaluate the user smoking event metrics against a plurality of smoking cessation badge conditions, each smoking cessation badge condition identifying a smoking cessation badge from a plurality of smoking cessation badges.

15. The system of claim 14, wherein the electronic device is configured to store data associated with the plurality of smoking events in an encrypted format.

16. The system of claim 14, wherein the server is further configured to determine a discrepancy between the information and a previously stored information, the discrepancy being an indication that the information is different from the previously stored information, and resolve the discrepancy based at least on a timeline of the information and the previously stored information.

17. The system of claim 14, wherein the server is further configured to issue a smoking cessation badge from the plurality of smoking cessation based on the evaluating step to the user, track which smoking cessation badges in the plurality of smoking cessation badges have previously been issued to the user, and display the issued smoking cessation badges to the user through the electronic device.

18. The system of claim 14, wherein the server is further configured to receive a request from the electronic device to create a smoking cessation plan, transmit at least one query to the electronic device, the at least one query being associated with at least one smoking style attribute, receive at least one response to the at least one query from the electronic device, and develop a tailored plan associated with the user based at least in part on the at least one response.

19. The system of claim 18, wherein the at least one response is a desired quit date.

20. The system of claim 18, wherein the at least one response is a preferred type of cigarette.
